(19) United States
(12) Patent Application Publication
(10) Pub. No.: US 2014/0026694 A1
(43) Pub. Date: Jan. 30, 2014

(54) PRESSURE PIECE OF A RACK-AND-PINION STEERING SYSTEM

(71) Applicant: Hans Walter Wodtke, Hennef (DE)

(72) Inventor: Hans Walter Wodtke, Hennef (DE)

(73) Assignee: SCHAEFFLER TECHNOLOGIES AG & CO KG, HERZOGENAURACH (DE)

(21) Appl. No.: 14/110,629

(22) PCT Filed: Mar. 19, 2012
(86) PCT No.: PCT/EP12/54786

§ 371 Date: Oct. 8, 2013

(30) Foreign Application Priority Data
May 9, 2011 (DE) 10 2011 075 496.2

(51) Int. Cl. B62D 3/12

(52) U.S. Cl. CPC B62D 3/123
USPC 74/30; 74/409

(57) ABSTRACT

Pressure piece (9) of a rack-and-pinion steering system, wherein the pressure piece (9) can be pressed along a pressure axis (D) against a rack (5), wherein the pressure piece (9) has a guide (14) for the rack (5) along its rack axis (Z), wherein an adjusting device (17) for adjusting the guide (14) of the pressure piece (9) along an adjusting axis (S) is provided, wherein the adjusting axis (S) intersects a plane containing the pressure axis (D) and also the rack axis (Z). It is possible to place the rack (5) off-axis in a targeted manner in order to reduce unwanted noise.

The present invention concerns a pressure piece of a rack-and-pinion steering system of an automotive vehicle, as also a rack-and-pinion steering system comprising this pressure piece.

### BACKGROUND

U.S. Pat. No. 6,644,432 B1 discloses an electromechanical rack-and-pinion steering system in which a ball screw drive driven by an electro motor is used for assisting the steering system. A toothed rack of a rack-and-pinion steering system comprises a section in whose toothing a steering pinion that is connected to a steering shaft engages. Steering movements of the driver are converted by the steering shaft and the steering pinion into tranlational displacements of the toothed rack.

This toothed rack comprises a section that is configured as a threaded spindle. This threaded spindle possesses a spindle nut on which a drive pinion is arranged rotationally fast. The system further comprises a belt drive in which a toothed belt is wound round the motor pinion of the electro motor and round the drive pinion of the spindle nut. The spindle nut is mounted through a double-row deep groove ball bearing in a steering housing. For this purpose, the steering housing comprises a receptacle as a bearing seat for the deep groove ball bearing, an outer ring of the deep groove ball bearing being inserted in a known manner with a tight abutting fit into the bearing seat.

For obtaining a smooth running of the ball screw drive, the spindle nut is usually mounted rotatably on the threaded spindle with almost no lash and with inter-positioning of balls on the threaded spindle. The balls roll on one side on a ball groove of the threaded spindle and on the other side on ball grooves of the spindle nut. The ball grooves of the spindle nut and of the threaded spindle define endless ball channels in which the balls circulate endlessly.

In the ideal case, the axes of the threaded spindle, the spindle nut and the deep groove ball bearing as also of the bearing seat of the steering housing are aligned to one another, that is, they are coincident.

For a flawless engagement of the steering pinion that is connected to the steering rod through the toothing of the toothed rack, usually a so-called pressure piece that presses the toothed rack against the steering pinion along a pressure axis is used. The pressure piece can be suspended resiliently against the back of the toothed rack through a spring element that is supported on the steering housing, the pressure axis in this case being a spring axis. The back of the toothed rack is situated opposite the toothing section on the peripheral side. With the help of the pressure piece, a lash-free engagement of the steering pinion into the toothing of the toothed rack is guaranteed. Together with the mounted steering pinion, the pressure piece can form a mounting point for the toothed rack in the steering housing.

The pressure piece usually comprises a receptacle that is defined by walls of the receptacle, the toothed rack engaging with its back into this receptacle. The toothed rack is guided for longitudinal displacement in the receptacle. The toothed rack is guided in crosswise direction of the longitudinal axis of the toothed rack for longitudinal displacement on the walls of the receptacle.

FIG. 7 shows a cross-section through a prior art rack-and-pinion steering system. A steering shaft 1 is mounted through a ball bearing 3 and a needle roller bearing 4 in a steering housing 2. A toothed rack 5 is arranged in the steering housing 2. The steering shaft 1 comprises a steering pinion 6 that is arranged between the needle roller bearing 4 and the ball bearing 3. The steering pinion 6 meshes with a toothing 7 that is configured on the toothed rack 5. A pressure piece 9 that is arranged in the steering housing 2 is pressed against a back 8 of the toothed rack 5, which back 8 is situated opposite the toothing 7. The pressure piece 9 suspends the toothed rack 5 resiliently against the steering pinion 6 and thus realizes a lash-free engagement of the steering pinion 6 with toothing 7 of the toothed rack 5. The pressure piece 9 is resiliently suspended in direction of the back 8 of the toothed rack 5 through a coil compression spring 10.

### SUMMARY OF THE INVENTION

It has been observed that undesired rattling noises become audible depending on the position of the toothed rack in the steering housing.

It is an object of the present invention to eliminate this drawback.

The present invention provides an inventive pressure piece and inventive rack-and-pinion steering system comprising this pressure piece. By the fact that an adjusting device for adjusting the guide of the pressure piece along an adjusting axis is provided and that this adjusting axis intersects a plane containing the pressure axis and also the toothed rack axis, it is possible to achieve a flawless adjustment of the guide.

A desired deflection or tilting of the toothed rack relative to the steering housing, which can also be designated as a controlled offsetting of the toothed rack from the axis, can be achieved with the inventive pressure piece. Through this controlled offsetting, the toothed rack tilts in the steering housing with the result that undesired noises can be clearly reduced.

With a rack-and-pinion steering system comprising an electromotive actuation of the ball screw drive, the inventive pressure piece enables an adjustment of a lash in the ball screw drive such that noises generated by the ball screw drive can be clearly reduced. On the one hand, the ball channel for balls is narrowed and on the other hand a lash in the support bearing of the ball screw drive is also reduced; the support bearing mounts the driven spindle nut in the steering housing.

The spindle nut cannot follow the axis offset of the toothed rack because the spindle nut is fixed in position on the steering housing through the rolling bearing mounting. A pivoting ability of the rolling bearing mounting is generally not provided because, for operational reasons, in the described use, the spindle nut transmits tilting moments into the steering housing. As a result of the axis offset, the threaded spindle is tilted relative to the spindle nut such that the balls run in a narrowed ball channel. An axis offset for example of 0.2 degrees to 0.3 degrees relative to the normal position of the toothed rack can suffice to eliminate the undesired rattling noises. A normal position is given when no tilting of the toothed rack relative to the spindle nut is adjusted.

This adjusting movement for the axis offset of the toothed rack comprises at least one movement component that is oriented crosswise to the longitudinal axis of the toothed rack. In this crosswise direction, the guide of the pressure piece entrains the toothed rack. For this purpose, the pressure piece can comprise, in a known manner, the receptacle defined by the receptacle walls, into which receptacle, the toothed rack engages with its back. The lateral walls of the receptacle arranged on the two longitudinal sides of the toothed rack partially surround the toothed rack so that, during the adjusting movement of the pressure piece, the toothed rack is pressed against one of the two receptacle walls and offset from its axis.

The guide of the pressure piece can be advantageously locked in direction of the adjusting axis by a locking device. When a suitable position of the guide is adjusted in which rattling noises do not occur, the locking device can be actuated so that no further movements of the guide along the adjusting axis are possible. For realizing the locking device, it is possible, for instance, to use screws or detents.

For instance, if the pressure piece has a multi-part configuration and is made up of an upper part that comprises the guide and of a lower part, the upper part can be locked through the locking device in the adjusted position on the lower part in the aforesaid manner. The lower part can be configured for displacement along the pressure axis but not along the adjusting axis.

On the one hand, the invention assures that the pressure piece can be resiliently suspended in a known manner against the back of the toothed rack. The pressure axis of the pressure piece and the longitudinal axis of the toothed rack are situated in one plane, and the adjusting axis intersects this plane. The position of the adjusting axis is chosen so that a displacement of the pressure piece along the adjusting axis does not deteriorate the resilient suspension of the pressure piece against the toothed rack; a flawless engagement of the steering pinion into the toothing of the toothed rack is assured.

On the other hand, through the inventive adjusting device, the toothed rack can be offset from the axis in the aforesaid manner so that undesired rattling noises are avoided.

For reducing friction, a lash is often provided in the ball screw drive, and in the presence of rapid alternating movements, this lash can give rise to noises. An excessively narrow lash in the ball screw drive can lead to an undesired high push-through force. By this push-through force is meant the force under which the toothed rack can be translationally moved, this translational movement of the toothed rack being converted into a rotation of the spindle nut. In this case, the ball screw drive is driven in reverse direction and a translational displacement is converted into a rotation. This push-through force is of importance when the servo drive is not active and the rack-and-pinion steering system can be actuated exclusively through the steering force exerted on the steering wheel. The resetting forces applied by the chassis on the steering system enable wheels to be reset automatically for straight ahead driving. Excessively high push-through forces in combination with a very slight lash in the ball screw drive can make this resetting more difficult. On the other hand, an excessively large lash in the ball screw drive can cause undesired rattling noises.

The inventive adjusting device may comprise a spring element under whose spring force the pressure piece can be displaced along the adjusting axis. In this way, a resilient offsetting of the toothed rack from its axis can be achieved, so that an undesired lash in the ball screw drive or in its mounting on the steering housing is eliminated without an impermissibly high friction being created. Moreover, with this resilient tilting moment acting on the toothed rack, the lash in the ball screw drive can be chosen to be so large that geometric bracing in the ball screw drive in direction of the pressure axis of the pressure piece is avoided. This means that only the resilient suspension of the pressure piece against the toothed rack, known per se, can be realized without bracing between the spindle nut and the threaded spindle. The targeted resilient offset of the toothed rack with deflection of the guide of the pressure piece along the adjusting axis can enable a further desired lash reduction or lash elimination in the ball screw drive. The spring element enables an automatic re-adjustment of the pressure piece in order to eliminate undesired lash from the ball screw drive.

During operation of the rack-and-pinion steering system, radial forces from the toothed rack can be applied to the pressure piece, for instance through the engagement of a helical steering pinion. Depending on the further configuration of the inventive adjusting device, this can lead to the guide of the pressure piece being reset in the adjusting axis in opposition to the effective spring force of the spring element of the adjusting device. To assure that the pressure piece enables the longitudinal guidance of the toothed rack but does not permit other degrees of freedom crosswise to the longitudinal axis of the toothed rack, it can be appropriate to prevent a resetting of the pressure piece with help of suitable technical measures. For example, an adjusting movement can be accompanied by that much friction that a resetting is excluded. Here, recourse may be had to a self-locking, similar to a screw connection in which a thread pitch is that narrow that an axial loading of the screw cannot be converted into a relative rotation between the screw and the nut.

It can be likewise advantageous to avoid an excessive readjustment of the guide of the pressure piece with the help of the inventive adjusting device. In this case, after an adjustment of the pressure piece with the help of the adjusting device, the adjusting device can be locked or fixed through an appropriate means. Locking may be realized through positive engagement, fixing can be performed with the help of an adhesive that adhesively bonds those components to one another that must be movable with respect to one another for displacement of the pressure piece.

Pressure pieces configured according to the invention may also comprise adjusting devices that do not comprise the described spring element and still fulfill the intended purpose; adjusting devices without a spring element are suitable if the adjusted position of the pressure piece along the pressure axis is to remain unchanged, i.e. if the adjusting device has to be fixed or locked.

In a particularly favorable development of the invention, the pressure piece has a multi-part configuration, in which an adjusting part comprises the guide, the adjusting part being pivotally connected to a rotatable rotating part of the pressure piece through an eccentric.

Similar to known pressure pieces, such multi-part pressure pieces can likewise be received in a housing bore of the steering housing. Through the eccentric, it is possible, through a relative rotation of the rotating part with respect to the adjusting part, to realize a desired displacement of the adjusting part along the adjusting axis.

Further developments of this multi-part pressure piece are described in the dependent claims.

The eccentric is preferably arranged such that adjusting movements of the adjusting part do not lead to any undesired deterioration of the engagement of the steering pinion with the toothing of the toothed rack. The cylindrical rotating part can be arranged coaxially in the housing bore and be rotatable in the housing bore. The axis of the eccentric can be arranged parallel to the axis of the housing bore, and the axis of the housing bore can at the same time the pressure axis for the pressure piece.

### BRIEF DESCRIPTION OF THE DRAWINGS

The invention will be described more closely in the following with reference to an inventive rack-and-pinion steering system.

FIG. 1 shows a longitudinal section through an inventive rack-and-pinion steering system comprising an inventive pressure piece, in a schematic illustration,

FIG. 2 shows the rack-and-pinion steering system of FIG. 1, in a further longitudinal section,

FIG. 3 shows a longitudinal section through the pressure piece of FIG. 1,

FIG. 4 shows a view of the pressure piece of FIG. 3,

FIG. 5 shows an illustration similar to that of FIG. 3, but with displaced pressure piece,

FIG. 6 shows an illustration similar to that of FIG. 4, but with displaced pressure piece,

FIG. 7 shows a cross-section through a prior art rack-and-pinion steering system.

### DETAILED DESCRIPTION

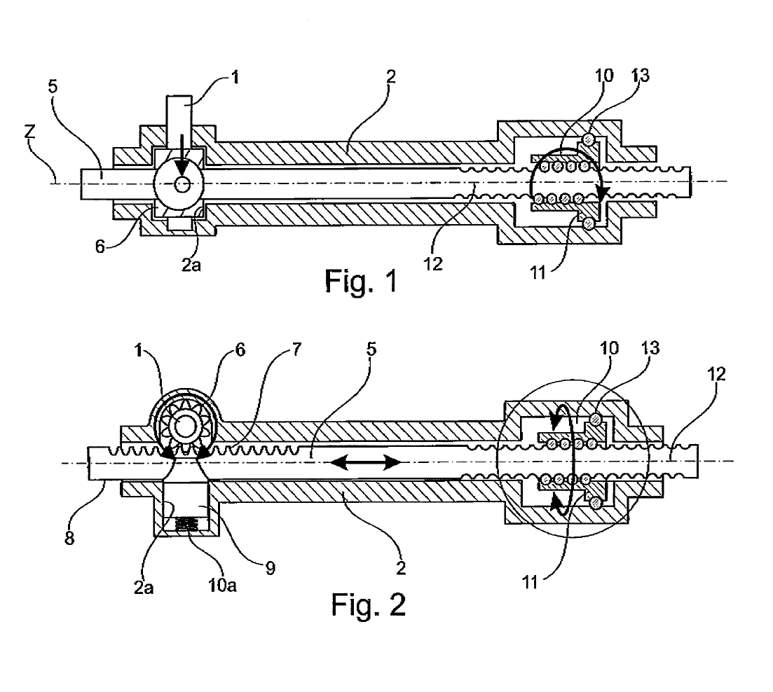

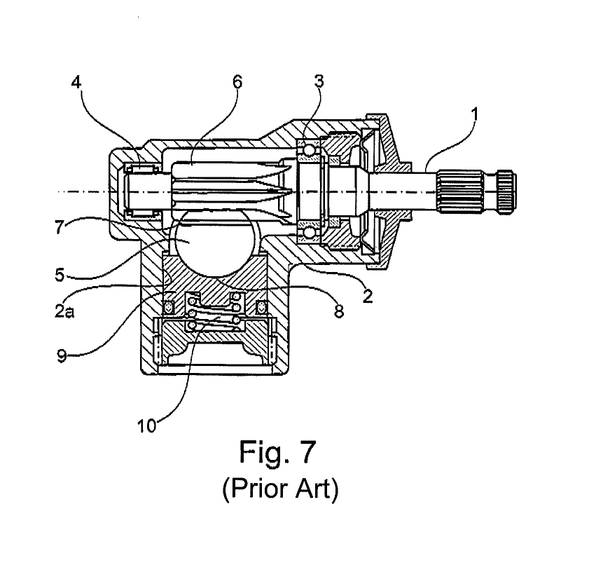

FIGS. 1 and 2 show an inventive rack-and-pinion steering system in two different longitudinal sections. Insofar as similarities to the prior art rack-and-pinion steering system of FIG. 7 exist, identical reference numerals are used.

A steering shaft 1 is mounted in a steering housing 2. A toothed rack 5 is arranged in the steering housing 2. The steering shaft 1 comprises a steering pinion 6. The steering pinion 6 meshes with a toothing 7 that is configured on the toothed rack 5. A pressure piece 9 that is arranged in a housing bore 2a of the steering housing 2 is pressed against a back 8 of the toothed rack 5, said back 8 being situated opposite the toothing 7. The pressure piece 9 suspends the toothed rack 5 resiliently against the steering pinion 6 and assures a lash-free engagement of the steering pinion 6 with the toothing 7 of the toothed rack 5. The pressure piece 9 is spring-biased by a coil compression spring 10 in direction of the back 8 of the toothed rack 5 along a pressure axis D.

A ball screw drive 10, known per se, and comprising a driven spindle nut 11 and a threaded spindle 12 is accommodated in the steering housing 2. The spindle nut 11 is rotatably mounted in the steering housing 2 through a ball bearing 13. Between the spindle nut 11 and the threaded spindle 12 are arranged balls, not shown, that roll in ball channels, not shown, that are defined by ball grooves of the threaded spindle 12 and of the spindle nut 11. The threaded spindle 12 is configured integrally on the toothed rack 5. The threaded spindle 12 and the toothed rack 5 possess a common toothed rack axis Z.

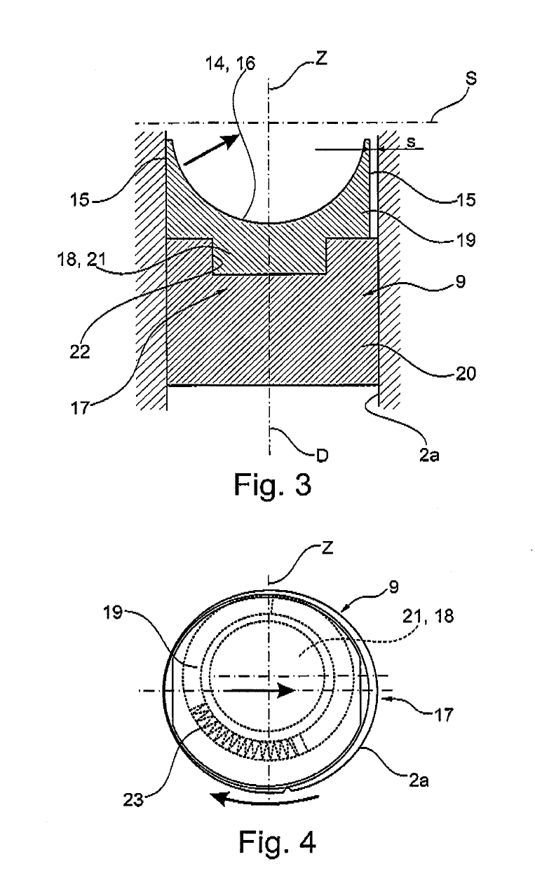

FIGS. 3, 4, 5 and 6 show the pressure piece 9 which is arranged in the housing bore 2a. The pressure piece 9 comprises in a known manner a guide 14 for the toothed rack 5. The guide 14 is formed by a receptacle 16 defined by receptacle walls 15, which receptacle 16 comprises, in the present case, an approximately cylindrical side wall. The toothed rack 5 engages with its back 8 into the receptacle 16.

The pressure piece 9 has a multi-part configuration and comprises an adjusting device 17 that is provided for displacing the guide 14 of the pressure piece 9 along an adjusting axis S. The adjusting axis S intersects a plane containing both the pressure axis D and the toothed rack axis Z. FIG. 3 shows the axes Z, D and S arranged in vertical relationship to one another. In the present example of embodiment, the adjusting axis S is arranged cross-wise to the plane in which the pressure axis D and the toothed rack axis Z are situated. Deviations from this right-angled arrangement are possible. What is important is, is that that the adjusting axis S be situated in a plane that intersects the plane in which the pressure axis D and the toothed rack axis Z are situated.

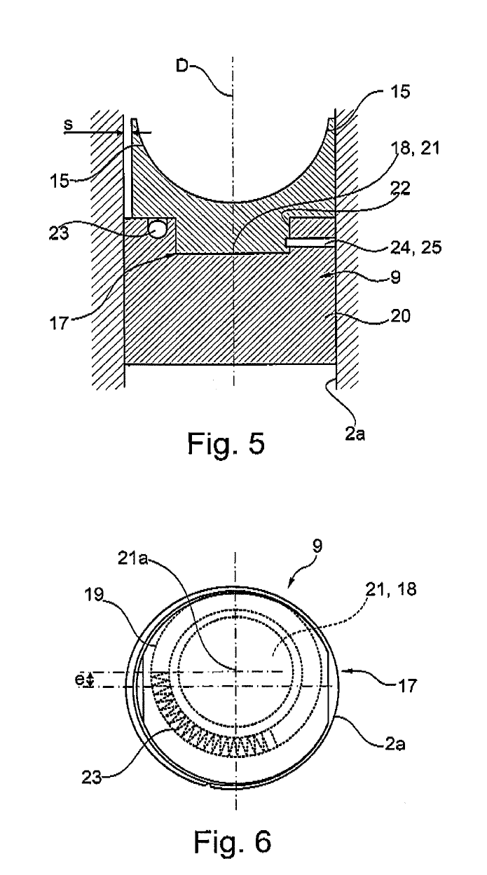

From FIGS. 3 and 5 it can be seen that through an actuation of the adjusting device 17, the pressure piece 9 is displaced through an adjusting path s along the adjusting axis S, and that, with the present arrangement of the axes, it is guaranteed that this displacement has no disadvantageous effect on the resilient suspension of the pressure piece 9 against the steering pinion 6.

The adjusting device 17 comprises an eccentric 18 that connects an adjusting part 19 of the pressure piece 9 and a rotating part 20 of the pressure piece 9 to each other. The adjusting part 19 comprises the guide 14 for the toothed rack 5. The rotating part 20 is arranged coaxially in the housing bore 2a and mounted for rotation. The axis 21a of the eccentric 18, the pressure axis D and the axis of the bore of the housing bore 2a are arranged parallel to one another. FIG. 6 shows the eccentricity e that is given through the distance between the center points of the eccentric axis 21a of the eccentric pin 21 and of the axis of the rotating part 20. The eccentric axis 21a is parallel to the pressure axis D and to the bore axis. Displacements of the pressure piece along the pressure axis D have no effect on the position of the eccentric axis 21a.

Through actuation of the adjusting device 17, the toothed rack is pressed cross-wise to its longitudinal axis against one of the two lateral receptacle walls 15 of the receptacle 16 and is entrained by the pressure piece 9 along the adjusting axis S. As a result, adjusting forces acting along the adjusting axis S are transmitted via the receptacle wall 15 to the toothed rack 5 for offsetting this from its axis.

FIGS. 3 and 5 clearly show an eccentric pin 21 of the eccentric 18 that is provided on the adjusting part 19 and that engages into an eccentric bore 22 of the rotating part 20. The eccentric bore 22 is arranged eccentrically to the longitudinal axis of the cylindrical rotating part 20.

The adjusting device 17 further comprises a spring 23 that is configured in the present example of embodiment as a coil compression spring. The spring 23 is supported on one side on the rotating part 20 and is biased on the other side against the adjusting part 21 of the pressure piece 9.

FIGS. 4 and 6 show the multi-part pressure piece 9 with the eccentric 18 in two end positions of the eccentric 18 in which the adjusting part 19 is displaced along the adjusting axis S.

Through actuation of the adjusting device 17, the toothed rack 5 is deflected or offset from its axis within the steering housing 2, while the toothed rack 5 tilts about the ball bearing 13 of the ball screw drive 10. Thus, through this tilting movement, the threaded spindle 12 tilts relative to the spindle nut 11, so that a lash of the balls arranged between the spindle nut 11 and the threaded spindle 12 can be narrowed or adjusted. With the inventive pressure piece 9, this lash can be influenced such that undesired rattling noises that are generated through a lash of the balls in the ball channel of the ball screw drive 10 can be eliminated.

The inventive pressure piece may comprise a locking device 24 in order to lock the pressure piece in an eccentric position in which the spring 23 is biased. After installation of the multi-part pressure piece 9 in the rack-and-pinion steering system, the locking device 24 can be disengaged so that, through the spring force of the spring 23, a twisting of the adjusting part 19 in the housing bore 2a and relative to the adjusting part 19 takes place and by reason of the eccentric 18, the adjusting part 19 of the pressure piece 9 is displaced along the adjusting axis S. When the intended position of the adjusting part 19 is reached, the locking device 24 can be re-activated so that a further pivoting of the rotating part 20 relative to the adjusting part 19 is excluded.

In the present example of embodiment or also in other inventive developments of the invention, the locking device 24 can be formed by a pin 25 (FIG. 5) that connects those parts to one another by positive engagement that have to be movable relative to one another for a displacement along the adjusting axis. The eccentric pin 21 may comprise a plurality of blind holes arranged spaced over its outer periphery. The pin 25 is arranged in a cross-bore of the rotating part 20 and is displaced into the suitable blind hole in the intended position of the adjusting part 19 so that a positive engagement connection is established between the adjusting part 19 and the rotating part 20 such that no further adjusting movements of the adjusting part 19 are possible. In place of this positive engagement connection, it is also possible to use a fast-hardening adhesive that connects the aforesaid parts of the pressure piece firmly to one another.

### REFERENCE NUMERALS

1 Steering shaft

2 Steering housing

2a Housing bore

3 Ball bearing

4 Needle roller bearing

5 Toothed rack

6 Steering pinion

7 Toothing

8 Back

9 Pressure piece

10 Ball screw drive

11 Spindle nut

12 Threaded spindle

13 Ball bearing

14 Guide

15 Receptacle wall

16 Receptacle

17 Adjusting device

18 Eccentric

19 Adjusting part

20 Rotating part

21 Eccentric pin

21a Eccentric axis

22 Eccentric bore

23 Spring

24 Locking device

25 Pin

What is claimed is:

1-15. (canceled)

16. A pressure piece of a rack-and-pinion steering system, the pressure piece pressable along a pressure axis against a toothed rack, the pressure piece comprising:
a guide for the toothed rack along a toothed rack axis; and
an adjuster for displacing the guide of the pressure piece along an adjusting axis, the adjusting axis intersecting a plane containing the pressure axis as well as the toothed rack axis.

17. The pressure piece as recited in claim 16 wherein the guide of the pressure piece is formed by a receptacle defined by a receptacle wall for an engagement of the toothed rack.

18. The pressure piece as recited in claim 17 wherein, through an actuation of the adjuster, adjusting forces acting along the adjusting axis are transmitted via the receptacle wall.

19. The pressure piece as recited in claim 16 wherein the adjuster comprises a spring through whose spring force the guide can be displaced along the adjusting axis.

20. The pressure piece as recited in claim 16 wherein an adjusting part of the pressure piece comprises the guide and is connected through an eccentric to a rotating part of the pressure piece.

21. The pressure piece as recited in claim 19 wherein an adjusting part of the pressure piece comprises the guide and is connected through an eccentric to a rotating part of the pressure piece, and wherein the spring element is connected on one side to the rotating part and on another side to the adjusting part.

22. The pressure piece as recited in claim 20 wherein an eccentric axis of the eccentric is arranged crosswise to the adjusting axis of the adjuster.

23. The pressure piece as recited in claim 20 wherein an eccentric axis is arranged parallel to the pressure axis of the pressure piece.

24. The pressure piece as recited in claim 20 wherein, in an adjusted state, the adjusting part is locked or fixed relative to the rotating part.

25. A rack-and-pinion steering system comprising:
a steering housing and a toothed rack arranged in the steering housing; and
the pressure piece as recited in claim 16 pressed along a pressure axis against the toothed rack, the pressure piece being arranged in a housing bore.

26. The rack-and-pinion steering system as recited in claim 25, wherein the guide of the pressure piece is formed by a receptacle defined by a receptacle wall for an engagement of the toothed rack, and the toothed rack engages into the receptacle and wherein the toothed rack is longitudinally slidably guided on receptacle walls situated on both longitudinal sides of the toothed rack.

27. The rack-and-pinion steering system as recited in claim 25 wherein an adjusting part of the pressure piece comprises the guide and is connected through an eccentric to a rotating part of the pressure piece, the rotating part being arranged coaxially in the housing bore and rotatable relative to the steering housing.

28. The rack-and-pinion steering system as recited in claim 25 wherein the pressure piece is resiliently suspended along the pressure axis which is arranged crosswise to the toothed rack axis, and wherein the adjusting axis is arranged crosswise to the toothed rack axis and also crosswise to the pressure axis.

29. The rack-and-pinion steering system as recited in claim 25 further comprising a ball screw drive, a spindle nut of the ball screw drive being arranged rotatably on a threaded spindle, and wherein the threaded spindle is formed as an axial elongation of the toothed rack, and the pressure piece is arranged axially spaced from the ball screw drive.

30. The pressure piece as recited in claim 16 wherein the guide is lockable in direction of the adjusting axis through a lock.
